(19) United States
(12) Patent Application Publication
(10) Pub. No.: US 2006/0191361 A1
(43) Pub. Date: Aug. 31, 2006

(54) Force generating apparatus

(75) Inventor: Chul-Woo Lee, Seongnam-si (KR)

Correspondence Address: STAAS & HALSEY LLP;JIM LIVINGSTON, SUITE 700, 1201 NEW YORK AVENUE, N.W., WASHINGTON, DC, 20005, US

(73) Assignee: Samsung Electronics Co. Ltd., Suwon-si (KR)

(21) Appl. No.: 11/353,022

(22) Filed: Feb. 14, 2006

(30) Foreign Application Priority Data
Feb. 28, 2005 (KR) 10-2005-16396

(51) Int. Cl. F16H 27/04

(52) U.S. Cl. 74/84 S

(57) ABSTRACT

A force generating apparatus includes first and second rotating bodies arranged parallel to each other, a connection member coupled to the first and second rotating bodies and circulating between the first and second rotating bodies, and a centrifugal force generator having a coupling unit coupled to the connection member and a weight connected to the coupling unit to change a horizontal distance from the connection member. Since a horizontal distance from the weight to a rotational center of the first rotating body when the centrifugal force generator rotates around the first rotating body is greater than a horizontal distance from the weight to a rotational center of the second rotating body when the centrifugal force generator rotates around the second rotating body, a thrust force in a direction from the second rotating body to the first rotating body is generated.

### CROSS-REFERENCE TO RELATED APPLICATIONS

This application claims the benefit of Korean Patent Application No. 10-2005-0016396, filed on Feb. 28, 2005, in the Korean Intellectual Property Office, the disclosure of which is incorporated herein in its entirety by reference.

### BACKGROUND OF THE INVENTION

1. Field of the Invention

The present invention relates to a force generating apparatus, and more particularly, to a force generating apparatus which generates acceleration to move an object in a selected direction.

2. Description of the Related Art

FIGS. 1 through 3 show examples of conventional force generating apparatuses. Referring to FIGS. 1 through 3, the conventional methods to move an object will be described below.

FIG. 1 shows a force generating apparatus adopting a belt 13 as a power transfer means to transfer power of a motor 12. A rotatable wheel 11 is installed on a body 14. The body 14 can move on a ground 15 where a frictional force exists by rotating the wheel 11 using the belt 13 that transfers a rotational force of the motor 12 fixed to the body 14. However, the force generating apparatus of FIG. 1 has a problem in that the body 14 can be moved only on the ground 15 where a frictional force acts.

FIG. 2 shows a force generating apparatus that propels a body 18 without being dependent on a frictional force. Referring to FIG. 2, the force generating apparatus includes a motor 16 fixed to the body 18 and a propeller 17 rotated by the motor 16. As the propeller 17 rotates, a medium in space that is gas or liquid is pushed backward so that the body 18 can move forward in the space by relative reaction. However, the force generating apparatus of FIG. 2 has a problem in that the force is generated only in a state where a medium such as gas or liquid exists and a large amount of medium is expelled in a direction opposite to the direction in which the body 18 moves. Thus, the field in which the force generating apparatus can be used is limited.

FIG. 3 shows a force generating apparatus that expels an arbitrary amount of mass 22 out of a body 23 to move the body 23 in space by reaction thereof. Mass 22 is expelled at a predetermined speed from a kinetic energy generating unit 21 fixed to the body 23. However, the force generating apparatus of FIG. 3 has a problem in that the mass 22 that is expelled cannot be continuously refilled without stopping the apparatus so that a driving distance and time is short. Accordingly, the force generating apparatus is used in a limited field such as a rocket and a space shuttle.

### SUMMARY OF THE INVENTION

To solve the above and/or other problems, the present invention provides a force generating apparatus which can move an object by generating acceleration in a particular direction in a method different from the conventional method.

According to an aspect of the present invention, there is provided a force generating apparatus including first and second rotating bodies arranged parallel to each other, a connection member coupled to the first and second rotating bodies and circulating between the first and second rotating bodies, and a centrifugal force generator having a coupling unit coupled to the connection member and a weight connected to the coupling unit to change a horizontal distance from the connection member. Since a horizontal distance from the weight to a rotational center of the first rotating body when the centrifugal force generator rotates around the first rotating body is greater than a horizontal distance from the weight to a rotational center of the second rotating body when the centrifugal force generator rotates around the second rotating body, a thrust force in a direction from the second rotating body to the first rotating body is generated.

The diameter of the first rotating body may be the same as that of the second rotating body.

A plurality of the centrifugal force generators may be coupled to the connection member.

The force generating apparatus may further include a guide guiding a path of the weight.

In the centrifugal force generator, the weight may pivot up and down around the coupling unit so that the horizontal distance from the connection member changes.

In the centrifugal force generator, the weight may pivot back and forth around the coupling unit so that the horizontal distance from the connection member changes.

The connection member may be a belt or a chain.

Additional aspects and/or advantages of the invention will be set forth in part in the description which follows and, in part, will be apparent from the description, or may be learned by practice of the invention.

### BRIEF DESCRIPTION OF THE DRAWINGS

The above and other features and advantages of the present invention will become more apparent by describing in detail preferred embodiments thereof with reference to the attached drawings in which:

FIGS. 1 through 3 show examples of conventional force generating apparatuses;

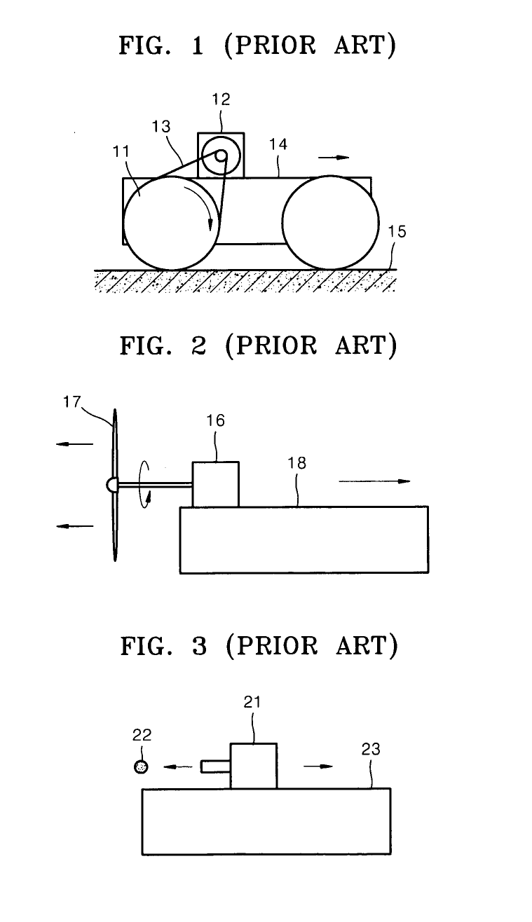

FIG. 4 is a perspective view of a force generating apparatus according to an embodiment of the present invention;

FIG. 5 is a plan view showing the inside of the force generating apparatus of FIG. 4; and

FIG. 6 is a plan view of a force generating apparatus according to another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

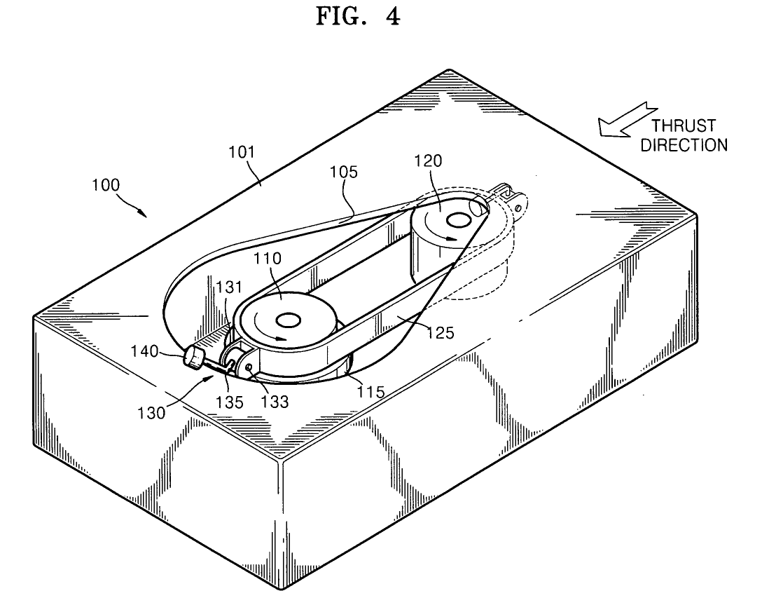

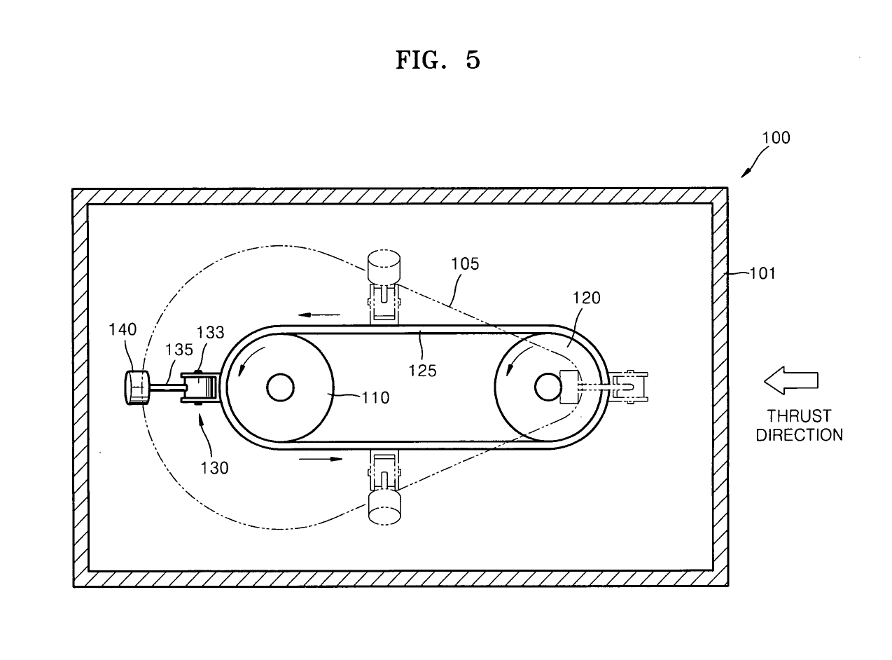

FIG. 4 is a perspective view of a force generating apparatus according to an embodiment of the present invention. FIG. 5 is a plan view showing the inside of the force generating apparatus of FIG. 4. Referring to FIGS. 4 and 5, a force generating apparatus 100 includes a housing 101, a first rotating body 110 and a second rotating body 120 rotatably installed in the housing 101, a belt 125 that is a connection member coupled between the first and second rotating bodies 110 and 120 and circulating therebetween, and a centrifugal force generator 130 coupled to the belt 125.

The first rotating body 110 is connected to a motor 115 fixed to the bottom of the housing 101 and rotated by a driving force of the motor 115. The second rotating body 120 is rotatably installed on the bottom of the housing 101. The first rotating body 110 and the second rotating body 120 are horizontally arranged at the same height and the diameters thereof are the same.

The belt 125 that circulates between the first and second rotating bodies 110 and 120 by a frictional force is formed of a rubber material to maintain an appropriate frictional force. Although it is not shown in the drawings, to prevent slippage between the belt 125 and the first and second rotating bodies 110 and 120, the outer circumferential surfaces of the first and second rotating bodies 110 and 120 can be processed to have a threaded surface while a threaded surface is formed on the inner circumferential surface of the belt 125 corresponding to the threaded surface of the first and second rotating bodies 110 and 120.

The centrifugal force generator 130 includes a coupling unit 131 coupled to the outer circumferential surface of the belt 125, a rod 135 bent like an “L” shape and hinge coupled to the coupling unit 131 by a pin 133, and a weight 140 provided at an end of the rod 135. The weight 140 can pivot up and down since the rod 135 is hinge coupled to the coupling unit 131. As the height of the weight 140 changes, the horizontal distance from the belt 125 to the weight 140 changes.

A guide 105 guiding a path of the weight 140 that moves as the belt 125 circulates is provided in the housing 101. The guide 105 guides the weight 140 to circulate along the path such that the horizontal distance between the weight 140 and the rotational center of the first rotating body 110 increases when the centrifugal generator 130 rotates around the first rotating body 110, and the horizontal distance between the weight 140 and the rotational center of the second rotating body 120 decreases when the centrifugal generator 130 rotates around the second rotating body 120. Although it is not shown in the drawings, the weight 140 can be coupled to the guide 105 such that the weight 140 can circulates along the guide 105 without escaping the guide 105.

When the motor 115 is operated so that the first rotating body 110 rotates as shown in FIGS. 4 and 5, the belt 125 circulates counterclockwise between the first and second rotating bodies 110 and 120 and the second rotating body 120 is passively rotated. The centrifugal force generator 130 coupled to the belt 125 circulates counterclockwise while the weight 140 circulates along a close curve formed by the guide 105.

As shown in FIG. 5, the horizontal distance from the rotational center of the first rotating body 110 to the weight 140 when the centrifugal force generator 130 circulates around the first rotating body 110 is greater than the horizontal distance from the rotational center of the second rotating body 120 to the weight 140 when the centrifugal force generator 130 circulates around the second rotating body 120. Thus, imbalance in the centrifugal force is generated so that the centrifugal force of the first rotating body 110 is greater than that of the second rotating body 120, thus generating a thrust force in a direction indicated by an arrow. In the meantime, an inertia force generated when the centrifugal force generator 130 linearly moved from the first rotating body 110 to the second rotating body 120 is offset by the inertia force generated when the centrifugal force generator 130 linearly moved from the second rotating body 120 to the first rotating body 110.

When an object to move is integrally formed with the housing 101 or connected thereto, the object can be moved in the thrust direction indicated by the arrow. A plurality of centrifugal force generators can be coupled to the belt 125. A force generating apparatus having a plurality of centrifugal force generators has a greater amount of a thrust force while vibration is reduced.

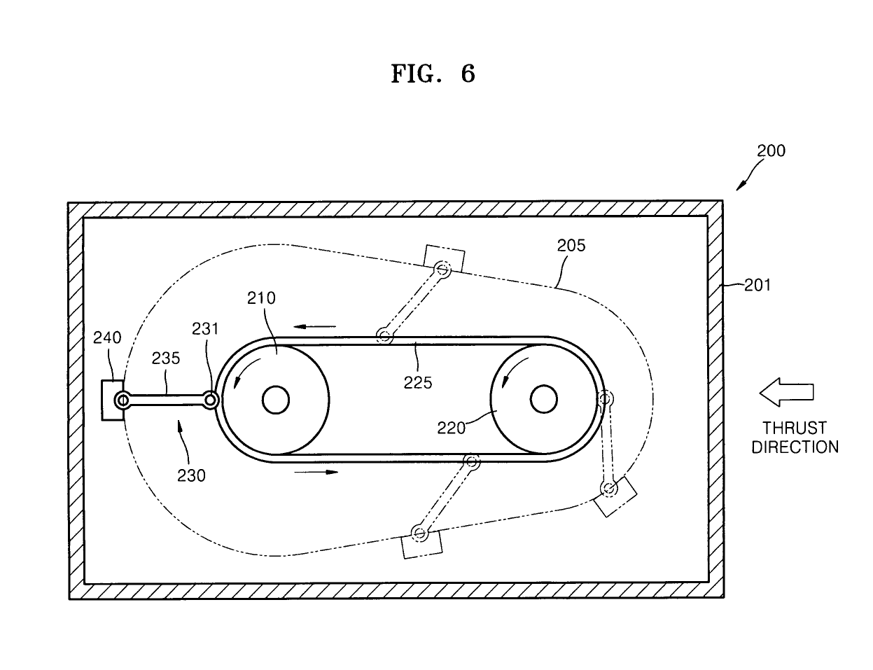

FIG. 6 is a plan view of a force generating apparatus according to another embodiment of the present invention. Referring to FIG. 6, like the force generating apparatus 100 of FIGS. 4 and 5, a force generating apparatus 200 according to the present embodiment includes a housing 201, a first rotating body 210 and a second rotating body 220 provided in the housing 201, a belt 225 circulating between the first and second rotating bodies 210 and 220, a centrifugal force generator 230 coupled to the belt 225, and a guide 205 guiding a path of a weight 240 of the centrifugal force generator 230.

In the centrifugal force generator 230, unlike the force generating apparatus 100 of FIGS. 4 and 5, a rod 235 where the weight 240 is provided pivots back and forth around the coupling unit 231 and hinge coupled to the coupling unit 231 so that the horizontal distance from the belt 225 to the weight 240 can vary. Also, since the guide 205 guides the weight 240 such that the weight 240 can circulate on a single plane, the guide 205 is formed without a change in the height from the bottom of the housing 210 to a certain height unlike the guide 105 of FIG. 4.

When the first rotating body 210 rotates so that the belt 225 circulates counterclockwise, the weight 240 of the centrifugal force generator 230 circulates along the guide 205. Since the horizontal distance from the first rotating body 210 to the weight 240 when the centrifugal force generator 230 rotates around the first rotating body 210 is greater than the horizontal distance from the second rotating body 220 to the weight 240 when the centrifugal force generator 230 rotates around the second rotating body 220, imbalance in the centrifugal force is generated so that a thrust force is generated in a direction indicated by an arrow. A plurality of centrifugal force generators can be coupled to the belt 225. A force generating apparatus having a plurality of centrifugal force generators has a greater amount of a thrust force while vibration is reduced.

The force generating apparatus according to the present invention generates a thrust force to move an object in a particular direction in a way different from the conventional method. Thus, the force generating apparatus according to the present invention can be used as a force generating apparatus moving an object in a variety of fields to which the conventional force generating apparatus cannot be applied or where the application of the conventional force generating apparatus is limited. For example, the force generating apparatus according to the present invention can be applied to a head transfer actuator of a hard disk drive, an optical pickup actuator transfer system of an optical disk drive, and a disk tilt correction apparatus. Furthermore, the force generating apparatus according to the present invention can be applied to a home robot, an unmanned monitor, or a part carrying vehicle.

While this invention has been particularly shown and described with reference to preferred embodiments thereof, it will be understood by those skilled in the art that various changes in form and details may be made therein without departing from the spirit and scope of the invention as defined by the appended claims. For example, the connection member of the force generating apparatus according to the present invention may be a chain instead of a belt.

What is claimed is:

1. A force generating apparatus comprising:
first and second rotating bodies arranged parallel to each other;
a connection member coupled to the first and second rotating bodies and circulating between the first and second rotating bodies; and
a centrifugal force generator having a coupling unit coupled to the connection member and a weight connected to the coupling unit to change a horizontal distance from the connection member,
wherein, since a horizontal distance from the weight to a rotational center of the first rotating body when the centrifugal force generator rotates around the first rotating body is greater than a horizontal distance from the weight to a rotational center of the second rotating body when the centrifugal force generator rotates around the second rotating body, a thrust force in a direction from the second rotating body to the first rotating body is generated.

2. The force generating apparatus of claim 1, wherein the diameter of the first rotating body is the same as that of the second rotating body.

3. The force generating apparatus of claim 1, wherein a plurality of the centrifugal force generators are coupled to the connection member.

4. The force generating apparatus of claim 1, further comprising a guide guiding a path of the weight.

5. The force generating apparatus of claim 1, wherein, in the centrifugal force generator, the weight pivots up and down around the coupling unit so that the horizontal distance from the connection member changes.

6. The force generating apparatus of claim 4, further comprising a guide guiding a path of the weight.

7. The force generating apparatus of claim 1, wherein, in the centrifugal force generator, the weight pivots back and forth around the coupling unit so that the horizontal distance from the connection member changes.

8. The force generating apparatus of claim 5, further comprising a guide guiding a path of the weight.

9. The force generating apparatus of claim 1, wherein the connection member is a belt.

10. The force generating apparatus of claim 1, wherein the connection member is a chain.

11. A method of generating force, comprising:
rotating a first body and a second body parallel to each other;
connecting the first and second rotating bodies by a connecting member; and
pivotally coupling a weight to the connecting member so that a horizontal distance from the weight to the connection member may vary,
wherein, since a horizontal distance from the weight to a rotational center of the first rotating body when the centrifugal force generator rotates around the first rotating body is greater than a horizontal distance from the weight to a rotational center of the second rotating body when the centrifugal force generator rotates around the second rotating body, a thrust force in a direction from the second rotating body to the first rotating body is generated.

12. The method of claim 11, wherein the diameter of the first rotating body is the same as that of the second rotating body.

13. The method of claim 11, further comprising coupling a plurality of weights to the connecting member so that a horizontal distance from the weights to the connection member may vary.

14. The method of claim 11, further comprising guiding the weight in a path.

15. The method of claim 11, wherein the weight pivots up and down around the coupling unit so that the horizontal distance from the connection member changes.

16. The method of claim 14, further comprising guiding the plurality of weights in a path.

17. The method of claim 11, wherein the connection member is a belt.

18. The method of claim 11, wherein the connection member is a chain.
